(19) United States
(12) Patent Application Publication
(10) Pub. No.: US 2025/0298117 A1
(43) Pub. Date: Sep. 25, 2025

(54) ASSESSMENT OF POSITION ESTIMATE QUALITY USING LINE OF SIGHT PREDICATIONS

(71) Applicant: QUALCOMM Incorporated, San Diego, CA (US)

(72) Inventors: Songwon JEE, San Jose, CA (US); Himanshu SHAH, Milpitas, CA (US); William MORRISON, San Francisco, CA (US); Chandrasekhar JAYARAM, Bangalore (IN); Anusha VARDHINENI, Bangalore (IN); Bo ZHENG, Sunnyvale, CA (US); Yuxiang PENG, Sunnyvale, CA (US); Tejas DALAL, San Diego, CA (US); Nimesh MAMNIA, San Diego, CA (US)

(21) Appl. No.: 18/609,447

(22) Filed: Mar. 19, 2024

(51) Int. Cl. G01S 5/02

(52) U.S. Cl. CPC G01S 5/0244; G01S 5/0218

(57) ABSTRACT

A method for assessing a quality of a position estimate for a user equipment (UE) includes: identifying one or more devices as a line-of-sight (LOS) device based on a classification of one or more measurements from the one or more devices as being LOS measurements; determining one or more LOS postfit residuals for each LOS device based on the position estimate for the UE and the LOS measurements from the LOS device; and determining a quality metric for the position estimate for the UE based on the one or more LOS postfit residuals corresponding to the LOS devices.

### BACKGROUND

Wireless communication systems, such as Global navigation satellite systems (GNSS), cellular systems, and other wireless networks, are used to determine a position and/or location of any number of mobile stations. A wireless communication system may include one or more devices that each transmit a time-synchronized signal. A mobile station may receive the time-synchronized signal from a number of the devices. By determining a time of transmission associated with each received time-synchronized signal and having knowledge of the location of each of the devices that transmitted each received time-synchronized signal, the mobile station may determine its location. However, The resolution of the location may be reduced when the time-synchronized signals are obstructed by natural and man-made barriers, such as mountains, canyons, urban canyons, and tunnels, affecting the reliability of the determination of the mobile station location.

### SUMMARY

An example method for assessing a quality of a position estimate for a user equipment (UE) includes: identifying one or more devices as a line-of-sight (LOS) device based on a classification of one or more measurements of one or more signals from the one or more devices as being LOS measurements; determining one or more LOS postfit residuals for each LOS device based on the position estimate for the UE and the LOS measurements from the LOS device; and determining a quality metric for the position estimate for the UE based on the one or more LOS postfit residuals corresponding to the LOS devices.

An example non-transitory, processor-readable storage medium includes processor-readable instructions to cause one or more processors to: identify one or more devices as a LOS device based on a classification of one or more measurements of one or more signals from the one or more devices as being LOS measurements; determining one or more LOS postfit residuals for each LOS device based on a position estimate for the UE and the LOS measurements from the LOS device; and determining a quality metric for the position estimate for the UE based on the one or more LOS postfit residuals corresponding to the LOS devices.

An example UE includes: a receiver; one or more memories; and one or more processors communicatively coupled to the one or more memories, the one or more processors being configured to: identify one or more devices as a LOS device based on a classification of one or more measurements of one or more signals, from the one or more devices and received by the receiver, as being LOS measurements; determine one or more LOS postfit residuals for each LOS device based on a position estimate for the UE and the LOS measurements from the LOS device; and determine a quality metric for the position estimate for the UE based on the one or more LOS postfit residuals corresponding to the LOS devices.

An example UE includes: means for identifying one or more devices as a line-of-sight (LOS) device based on a classification of one or more measurements of one or more signals from the one or more devices as being LOS measurements; means for determining one or more LOS postfit residuals for each LOS device based on the position estimate for the UE and the LOS measurements from the LOS device; and means for determining a quality metric for the position estimate for the UE based on the one or more LOS postfit residuals corresponding to the LOS devices.

### BRIEF DESCRIPTION OF THE DRAWINGS

FIG. 1 illustrates a simplified diagram of an example wireless communication system.

FIG. 2 illustrates an example user equipment.

FIG. 3 illustrates a flow diagram of a method for assessing a quality of a position estimate for a user equipment.

FIG. 4 illustrates a flow diagram of an example of the method of FIG. 3.

### DETAILED DESCRIPTION

Obtaining the locations of mobile devices may be useful for many applications including, for example, personal navigation, etc. Existing positioning methods include methods based on measuring radio signals transmitted from a variety of devices or entities, including satellite vehicles (SVs), terrestrial radio sources in a wireless network (such as base stations and access points), and any other device capable of wireless communication with the mobile device using one or more Radio Access Technologies (RATs) (e.g., IEEE 802.11 WiFi® (also referred to as Wi-Fi®), Bluetooth® (BT), and Ultra-wideband (UWB)). A positioning algorithm may be used to calculate a position estimate of a user equipment (UE) and a position estimate uncertainty value for the UE position estimate. The position estimate uncertainty value, however, does not directly assess the position estimate's accuracy. Embodiments described herein directly assesses the accuracy of the position estimate for the UE, based on one or more line-of-sight (LOS) postfit residuals calculated using measurements of one or more signals from one or more devices with a line-of-sight (LOS) with the UE. A quality metric for the position estimate may be calculated based on the one or more LOS postfit residuals, independently of the position estimate uncertainty value and the positioning algorithm used to determine the position estimate. The position estimate and the corresponding quality metric may be reported to an application. The application may use the quality metric to determine whether the reported position estimate meets a quality threshold.

The description herein may refer to sequences of actions to be performed, for example, by elements of a computing device. Various actions described herein can be performed by specific circuits (e.g., an application specific integrated circuit (ASIC), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® networks (e.g., based on IEEE (Institute of Electrical and Electronics Engineers) 802.11, etc.) and so on. Two or more UEs may communicate directly in addition to or instead of passing information to each other through a network.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (cMBB), or others) that may provide access for different types of devices. In some examples, the term “cell” may refer to a portion of a geographic coverage area (for example, a sector) over which the logical entity operates.

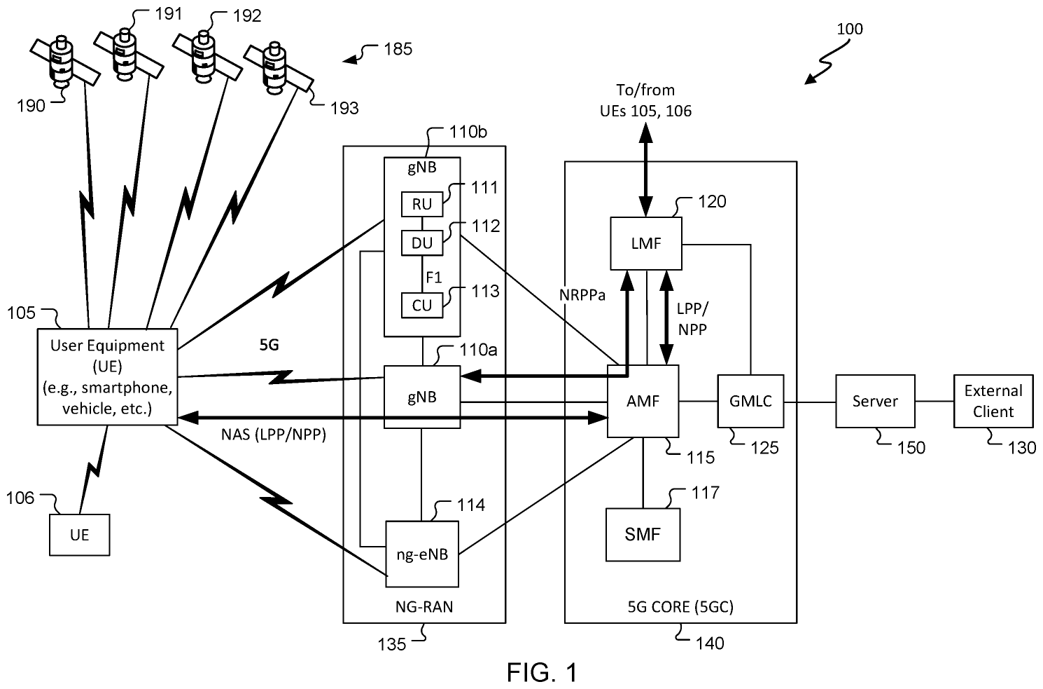

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or another device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-NB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi®, WiFi®-Direct (WiFi®-D), Bluetooth®, Bluetooth®-low energy (BLE), Zigbee®, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi® communication, multiple frequencies of Wi-Fi® communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi® (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH). Direct wireless-device-to-wireless-device communications without going through a network may be referred to generally as sidelink communications without limiting the communications to a particular protocol.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi® (also referred to as Wi-Fi®), Bluetooth® (BT), Worldwide Interoperability for Microwave Access (WiMax®), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi® Direct (WiFi®-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (ELTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share one or more processors but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi® AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi® access for the UE 105 and may comprise one or more WiFi® APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi® APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the position of the UE.

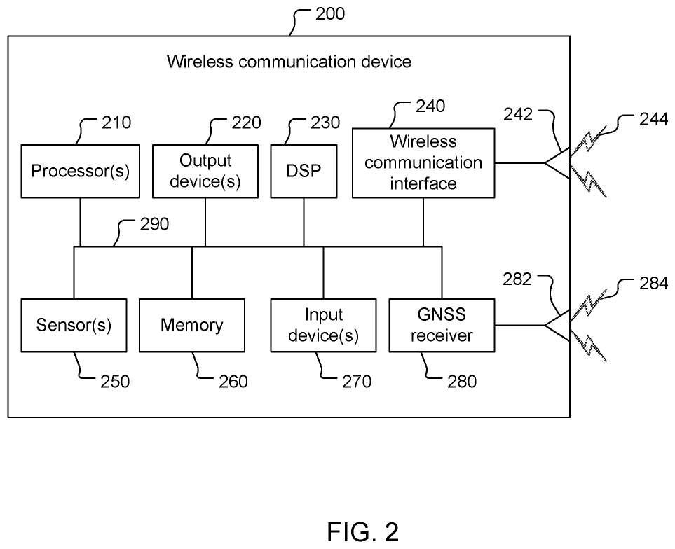

Referring also to FIG. 2, a wireless communication device 200, which is an example of the UE 105, includes one or more processors 210, one or more output devices 220, a DSP 230 (Digital Signal Processor), a wireless communication interface 240, one or more sensors 250, a memory 260, one or more input devices 270, and a GNSS receiver 280, communicatively coupled to each other by a bus 290. The processor(s) 210 may include one or more general-purpose processors, one or more special-purpose processors (such as DSP chips, graphics acceleration processors, application specific integrated circuits (ASICs), and/or the like), and/or other processing structures or means. The output device(s) 220 may include a display, a light emitting diode (LED), and/or one or more speakers, and/or the like. The DSP 230 may be separate from the processor(s) 210 or included in the processor(s) 210, e.g., depending on desired functionality. Location determination and/or other determinations based on wireless communication may be provided in the processor(s) 210 and/or the wireless communication interface 240 (discussed below). The sensor(s) 250 may include one or more inertial sensors and/or one or more other sensors (e.g., accelerometer(s), gyroscope(s), camera(s), magnetometer(s), altimeter(s), microphone(s), proximity sensor(s), light sensor(s), barometer(s), etc.), some of which may be used to obtain position-related measurements and/or other information, as described herein. The memory 260 may include local and/or network accessible storage, a disk drive, a drive array, an optical storage device, a solid-state storage device, such as a random access memory (RAM), and/or a read-only memory (ROM), which can be programmable, flash-updateable, etc. Such storage devices may be configured to implement any appropriate data stores, including without limitation, various file systems, database structures, etc. The input device(s) 270 may include a keyboard, a touch screen, a touch pad, a microphone, one or more buttons, one or more dials, and/or one or more switches, and/or the like. The GNSS receiver 280 may be configured to determine a location of the wireless communication device 200 based on received GNSS signals.

The wireless communication interface 240 may be configured to transmit and/or receive a variety of wireless signals 244 via an antenna 242. The wireless communication interface 240 comprise a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.). The wireless communication interface 240 may permit data and signaling to be communicated (e.g., transmitted and/or received) with a network, for example, via eNBs, gNBs, ng-eNBs, access points, various base stations and/or other access node types, TRPs, and/or other network components, computer systems, and/or any other appropriate electronic devices. The antenna 242 may comprise one or more discrete antennas, one or more antenna arrays, or any combination thereof.

Depending on desired functionality, the wireless communication interface 240 may comprise a separate receiver and transmitter, or any combination of transceivers, transmitters, and/or receivers to communicate with base stations (e.g., ng-eNBs and gNBs) and other terrestrial transceivers, such as wireless devices and access points. The wireless communication interface 240 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, etc. A CDMA network may implement one or more RATs such as CDMA2000, WCDMA, and so on. CDMA2000 includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000 is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. Techniques described herein may be used for any combination of WWAN, WLAN and/or WPAN.

The memory 260 may comprise one or more software elements (not shown). The software element(s) may include an operating system, device drivers, executable libraries, and/or other code, such as one or more application programs, which may comprise computer programs provided by various examples, and/or may be designed to implement methods, and/or configure systems, provided by other examples, as described herein. One or more procedures described with respect to the method(s) discussed herein may be implemented as code and/or instructions in the memory 260 that are executable by the processor(s) 210 and/or the DSP 230).

The GNSS receiver 280 may be capable of receiving GNSS signals 284 from one or more GNSS satellites via an antenna 282 (which could be the antenna 242). Positioning based on GNSS signal measurement may be utilized to complement and/or incorporate techniques described herein. The GNSS receiver 280 may be configured to determine a position of the wireless communication device 200 using conventional techniques, from the constellation 185 of GNSS SVs, such as Global Positioning System (GPS), Galileo, GLONASS, Quasi-Zenith Satellite System (QZSS) over Japan, Indian Regional Navigational Satellite System (IRNSS) over India, Beidou over China, etc. The GNSS receiver 280 may be used with various augmentation systems (e.g., a Satellite Based Augmentation System (SBAS)) that may be associated with or otherwise enabled for use with one or more global and/or regional navigation satellite systems, such as, e.g., WAAS, EGNOS, Multi-functional Satellite Augmentation System (MSAS), and Geo Augmented Navigation system (GAGAN), etc. The configuration of the UE 105 shown in FIG. 2 is an example and not limiting of the disclosure, including the claims, and other configurations may be used.

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AOD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference TRx-Tx (i.e., UE TRx-Tx or UERx-Tx) between the ToA of the RTT measurement signal and the transmission time of the RTT response message in a payload of each RTT response message. The RTT response message would include a reference signal from which the base station can deduce the ToA of the RTT response. By comparing the difference TTx-Rx between the transmission time of the RTT measurement signal from the base station and the ToA of the RTT response at the base station to the UE-reported time difference TRx-Tx, and subtracting the UERx-Tx, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-Positioning FrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every Nth resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence). Position information may include one or more positioning signal measurements (e.g., of one or more satellite signals, of PRS, and/or one or more other signals), and/or one or more values (e.g., one or more ranges (possibly including one or more pseudoranges), and/or one or more position estimates, etc.) based on one or more positioning signal measurements.

Referring to FIG. 2, in determining the position estimate for the UE 105, the UE 105 may configure one or more parameters of a positioning algorithm to “tune” the positioning performance. Such parameters may include a dilution of precision (DOP) or SV pseudorange weights modeling. The signals 244, 284 used to estimate the UE position may include non-direct signals, such as when the UE 105 is in a dense urban environment. Multipath interference may occur if the signals 244, 284 do not arrive directly from a device (i.e., no line of sight (LOS) between the UE 105 and the devices) but are reflected or diffracted, such as off of buildings or walls. Such reflections or diffractions cause the signals to travel paths of different lengths between the devices and the antennas 242, 282. Receipt of the multipath signals (e.g., the signals 244, 284 which are reflected or refracted) may lead to errors in the measurements of the signals 244, 284, which may result in errors in the distance measurements and the determination of the position estimate of the UE 105. The positioning algorithm may assess the measurement uncertainties for the measurement errors on the signals 244, 284 (e.g., carrier to noise ratio (C/No) and an elevation angle of a SV measurement). The postfit residuals and the measurement uncertainties may be used to compute a postfit residual covariance matrix, which is then used to estimate a statistical position estimate uncertainty value (e.g., 1-sigma) for the UE position estimate. However, the position estimate uncertainty value does not directly assess the position estimate's accuracy and is dependent on the positioning algorithm used to compute the position estimate. A position estimate's accuracy, as used herein, refers to how close the computed position estimate for the UE 105 is to the range measurements from the devices with a LOS with the UE 105. A position estimate may be associated with a position estimate uncertainty value that exceeds the certainty requirements of an application, although the position estimate may meet accuracy requirements. This may result in the application rejecting the reported position estimate.

The one or more embodiments described below directly assesses the accuracy of the position estimate for the UE 105 based on one or more postfit residuals determined using measurements of one or more signals from one or more devices with a LOS with the UE 105. The position estimate determined for the UE 105 may be compared with the range measurements from the one or more LOS devices. In the assessment, a quality metric for the position estimate may be determined based on the one or more postfit residuals from the LOS devices, independently of the position estimate uncertainty value and the positioning algorithm used to determine the position estimate.

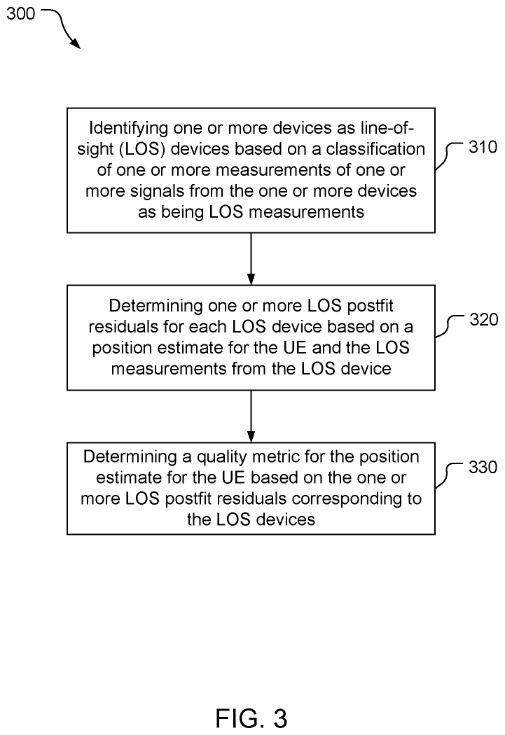

FIG. 3 illustrates a flow diagram for a method 300 for assessing a quality of a position estimate for a user equipment. The implementation of the method 300 includes the following features. At stage 310, the method 300 includes identifying one or more devices as LOS devices based on a classification of one or more measurements of one or more radio signals from the one or more devices as being LOS measurements. The one or more processors 210, possibly in combination with the one or more memories 260, may comprise means for implementing stage 310. At stage 320, the method 300 includes, determining one or more LOS postfit residuals for each LOS devices based on a position estimate for the UE 105 and the LOS measurements from the LOS device. The LOS postfit residuals represent one or more differences between one or more estimated distances (ranges) between each LOS device and the UE 105 and one or more actual range measurements for each LOS device. The one or more processors 210, possibly in combination with the one or more memories 260, may comprise means for implementing stage 320. At stage 330, the method 300 includes determining a quality metric for the position estimate for the UE 105 based on the one or more LOS postfit residuals corresponding to the LOS devices. The one or more processors 210, possibly in combination with the one or more memories 260, may comprise means for implementing stage 330.

In one example, the one or more devices may include one or more SVs 190-193. The UE 105 may include a Satellite Positioning System (SPS) receiver, a Session Manager (SM), a Measurement Engine (ME), and a Position Engine (PE), which may be implemented using one or more hardware, software, or a combination of hardware and software components of the UE 105 illustrated in FIG. 2. The SPS receiver (e.g., the GNSS receiver 280) may be capable of receiving signals 284 from acquired SVs 190-193 via the antenna 282. The antenna 282 is configured to transduce the signals 284 from wireless signals to wired signals, e.g., electrical, or optical signals. The one or more processors 210, the one or more memories 260, and/or one or more specialized processors (not shown) may be utilized to process signals 284, in whole or in part, and/or to calculate an estimated position of the UE 105, in conjunction with the SPS receiver. For example, the SPS receiver may be configured to determine a position estimate of the UE 105 by trilateration using the signals 284. The memory 260 may store indications (e.g., measurements) of the signals 284 and/or other signals for use in performing positioning operations. The SM facilitates communication between an application (possibly implemented by the one or more processors 210, possibly in combination with the one or more memories 260) and the ME and the PE. The SM receives a request from an application (e.g., a map or navigation application) for a position estimate for the UE 105. The SM sends the request to the ME, and the ME initiates a search for SVs. Upon acquiring SVs 190-193 and receiving signals 284 from the SVs 191-193, the ME measures the signals 284. The ME sends measurement reports containing the measurements of the signals 284 to the PE. The PE determines an estimate of the position estimate for the UE 105 using the measurements in the measurement reports according to one or more positioning algorithms. The PE sends the position estimate to the SM. The SM qualifies the position estimate for the UE 105, e.g., determines that the position estimate for the UE 105 meets the requirements of the application. The SM sends the qualified position estimate for the UE 105 to the application. If the SM does not qualify the position estimate for the UE 105, the position estimate is not sent to the application. The measurement of the signals 294 by the ME, the determination of the position estimate by the PE, and the qualification of the position estimate by the SM continues iteratively.

In another example, the one or more devices may include one or more base stations. The antenna 242 of the UE 105 may receive signals (e.g., signals 244) transmitted by the one or more base stations. The antenna 242 of the UE 105 may transduce the signals 244 from wireless signals to wired signals, e.g., electrical, or optical signals. The one or more processors 210, the one or more memories 260, and/or one or more specialized processors (not shown) may be utilized to process signals 282, in whole or in part, to calculate an estimate position of the UE 105.

In another example, the one or more LOS devices may include one or more devices (e.g., another UE 106) capable of wireless communication with the UE 105 using one or more RATs, such as Wi-Fi®, BT, and UWB. The antenna 242 of the UE 105 may receive signals (e.g., signals 244) transmitted by the one or more devices. The UE 105 may transduce the signals 244 from wireless signals to wired signals, e.g., electrical, or optical signals. The one or more processors 210, the one or more memories 260, and/or one or more specialized processors (not shown) may be utilized to process signals 282, in whole or in part, to calculate an estimate position of the UE 105.

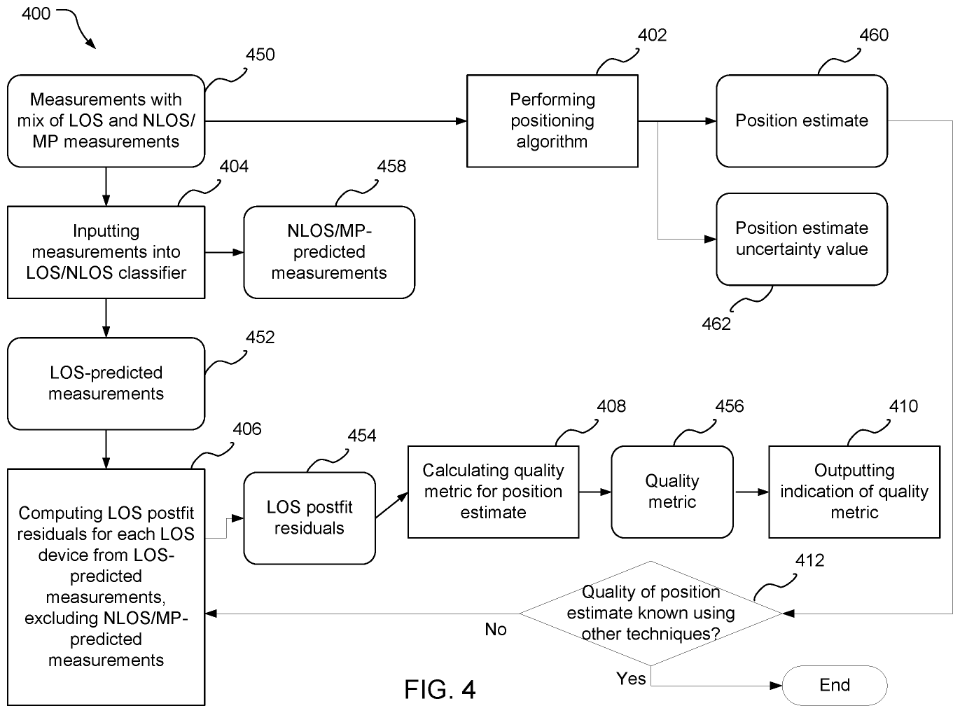

FIG. 4 illustrates a flow diagram of an example of the method 300 of FIG. 3. Implementations of the method 400 include the following features. At stage 402, the method 400 includes performing a positioning algorithm using the measurements 450 obtained from the one or more devices. The one or more processors 210, possibly in combination with the one or more memories 260, may comprise means for implementing stage 402. For example, for a GNSS-based position estimate, upon acquiring the minimum number of SVs for a position fix, the ME measures the signals 284 from the acquired SVs 190-193 and sends measurement reports containing the measurements to the PE. The measurements include a mix of LOS and NLOS/multipath (NLOS/MP) measurements 450 obtained from one or more SV's 190-193. The PE may use the measurements 450 in the measurement reports from the ME to calculate a position estimate 460 for the UE 105 according to a positioning algorithm and calculate a position estimate uncertainty value 462 corresponding to the position estimate 460. The PE may output a position estimate 460 for the UE 105 and a corresponding position estimate uncertainty value 462.

At stage 404, the method 400 includes inputting the one or more measurements 450 with the mix of LOS and NLOS/MP measurements into a LOS/NLOS classifier. The LOS/NLOS classifier identifies or predicts one or more measurements as LOS-predicated measurements 452 and one or more measurements as NLOS/MP-predicted SV measurements 458. One or more devices corresponding to the LOS-predicted measurements 452 may be identified as LOS devices. One or more devices corresponding to the NLOS/MP-predicted SV measurements 458 may be identified as non-LOS devices. The one or more processors 210, possibly in combination with the one or more memories 260, may comprise means for implementing stage 402.

For example, the LOS/NLOS classifier may be implemented to include a machine learning model and/or a statistical model. For another example, information from external sources, such as three-dimensional (3D) maps and ray tracing of the UE's environment (e.g., building maps or terrain maps) may be included in the classification of the one or more measurements 450. For example, the 3D map may include information indicating that the UE's environment includes a flat terrain with few obstructions (buildings, etc.), and the measurements may be classified as LOS measurements. If the 3D map indicates that the UE's environment includes a dense urban area with multiple obstructions or a mountainous terrain, then the measurements may be classified as NLOS measurements. Alternatively, or in combination, one or more of the other components of the UE 105 shown in FIG. 2, may be included in classifying the one or more measurements 450. The above described implementations of the LOS/NLOS classifiers are examples and are not limiting of the disclosure, including the claims, and other configurations of LOS/NLOS classifiers may be used.

At stage 406, the method 400 includes computing one or more LOS postfit residuals 454 (e.g., range residuals, such as pseudorange residuals and Doppler residuals) for each LOS device using the one or more LOS-predicated measurements 452 and the position estimate 460 of the UE 105. The LOS postfit residuals 454 represent one or more differences between one or more estimated distances (ranges) between each LOS device and the UE 105 and one or more actual range measurements for each LOS device. The NLOS/MP-predicted measurements 458 are excluded from the computing of the one or more LOS postfit residuals 454. The one or more processors 210, possibly in combination with the one or more memories 260, may comprise means for implementing stage 406.

At stage 408, the method 400 includes calculating a quality metric 456 for the position estimate 460 for the UE 105 based on the one or more LOS postfit residuals 454. For example, the quality metric 456 may be a mean, median, percentile, spread, or other statistical metric of the one or more LOS postfit residuals 454. The quality metric 456 represents a difference between the position estimate 460 for the UE 105, calculated using the positioning algorithm and the measurements 450 with the mix of LOS and NLOS measurements, and an expected position for the UE 105 based on the LOS-predicted measurements 452. The one or more processors 210, possibly in combination with the one or more memories 260, may comprise means for implementing stage 408.

At stage 410, the method 400 includes outputting an indication of the quality metric 456. For example, the quality metric 456 may be output to a display of the UE 105. For another example, the quality metric 456 may be reported to the application. The application may use the quality metric 456 to determine whether the position estimate 460 meets accuracy requirements. For example, the application may determine whether the quality metric 456 meets a quality threshold. The one or more processors 210, possibly in combination with the one or more memories 260, may comprise means for implementing stage 410.

At stage 412, the method 400 includes determining whether a quality of the current position estimate 460 may be known using other techniques. The one or more processors 210, possibly in combination with the one or more memories 260, may comprise means for implementing stage 412. In one example technique, 3D map information may be used to initially assess the quality of the position estimate 460. Terrain and/or weather information from 3D maps may be used to determine a reliability value of the current position estimate 460, where a terrain and/or weather information in the 3D maps may indicate LOS or NLOS between the one or more devices and the UE 105. For example, if the 3D map information indicate a probability of NLOS between the one or more devices and the UE 105, then the reliability value determined for the current position estimate 460 may fall below a reliability threshold. The current position estimate 460 may be determined to be of insufficient quality, and the current position estimate 460 may then be discarded without calculating the quality metric 456. For another example, if the 3D map information indicate a probability of LOS between the one or more devices and the UE 105, then the reliability of the current position estimate 460 may exceed the reliability threshold, where the current position estimate 460 may be determined to be of sufficient quality. The current position estimate 460 may then be reported without calculating the quality metric 456. For another example, the reliability value for the current position estimate 460 may be compared with a range of reliability values, where the lowest value in the range indicates insufficient quality and the highest value in the range indicates sufficient quality. If the reliability value for the current position estimate 460 falls between the lowest and highest values in the range, then the method 400 proceeds with stages 406-410 to further assess the accuracy of the position estimate 460.

In another example of the technique using 3D map information, the 3D map information may be used to determine another position estimate for the UE 105, using the measurements determined to be LOS measurements based on the 3D map information. This other position estimate may then be compared with the position estimate 460 to determine an offset between the two position estimates. For example, if the offset exceeds an offset threshold, then the position estimate 460 may be determined to be of insufficient quality. The current position estimate 460 may then be discarded without calculating the quality metric 456. For another example, if the offset is less than the offset threshold, then the position estimate 460 may be determined to be of sufficient quality. The current position estimate 460 may then be reported without calculating the quality metric 456. For another example, the offset may be compared with a range of offset values, where the lowest value in the range indicates sufficient quality and the highest value in the range indicates insufficient quality. If the offset falls within the range of offset values, then the method 400 may proceed with stages 406-410 to further assess the accuracy of the position estimate 460.

In another example technique, a displacement of the position of the UE 105 since the last position estimate may be estimated using one or more sensor signals from one or more sensors 250 (e.g., one or more inertial sensors). The position estimated determined using the sensor signals may be compared with the current position estimate 460 to determine an error. For example, if the error exceeds an error threshold, then the position estimate 460 may be determined to be of insufficient quality. The current position estimate 460 may then be discarded without calculating the quality metric 456. For another example, if the error falls below the error threshold, then the position estimate 460 may be determined to be of sufficient quality. The current position estimate 460 may then be reported without calculating the quality metric 456. For another example, the error may be compared with a range of values, where the lowest value in the range indicates sufficient quality and the highest value in the range indicates insufficient quality. if the error falls within the range, then the method 400 proceeds with stages 406-410 to further assess the accuracy of the position estimate 460.

In another example technique, another position estimate for the UE 105 may be determined using signals from one or more RATs. This other position estimate is then compared with the position estimate 460 to determine a difference between the two position estimates. For example, if the difference exceeds a threshold, then the position estimate 460 may be determined to be of insufficient quality. The current position estimate 460 may then be discarded without calculating the quality metric 456. For another example, if the difference is less than the threshold, then the position estimate 460 may be determined to be of sufficient quality. The current position estimate 460 may then be reported without calculating the quality metric 456. For another example, the difference may be compared with a range of values, where the lowest value in the range indicates sufficient quality and the highest value in the range indicates insufficient quality. If the difference falls within the range of values, then the method 400 may proceed with stages 406-410 to further assess the accuracy of the position estimate 460.

In another example technique, information from one or more cameras may be used to determine a reliability value for the current position estimate 460. One or more images captured by the one or more cameras may be analyzed to determine whether LOS or NLOS exists between the one or more devices and the UE 105. For example, the analysis of the one or more images may identify open space or obstructions between the one or more devices and the UE 105. For example, if the analysis of the one or more images indicates a probability of NLOS between the one or more devices and the UE 105, then the reliability value determined for the current position estimate 460 may fall below a reliability threshold, and the current position estimate 460 may be determined to be of insufficient quality. The current position estimate 460 may then be discarded without calculating the quality metric 456. For another example, if the analysis of the one or more images indicates a probability of LOS between the one or more devices and the UE 105, then the reliability of the current position estimate 460 may exceed the reliability threshold, where the current position estimate 460 may be determined to be of sufficient quality. The current position estimate 460 may then be reported without calculating the quality metric 456. For another example, the reliability value for the current position estimate 460 may be compared with a range of reliability values, where the lowest value in the range indicates insufficient quality and the highest value in the range indicates sufficient quality. If the reliability value for the current position estimate 460 falls between the lowest and highest values in the range, then the method 400 proceeds with stages 406-410 to further assess the accuracy of the position estimate 460.

In another example, the method 400 includes detecting movement or rotation of the UE 105 by the sensor(s) 250 and determining whether the measurements 450 are no longer relevant to the current position estimate 460. If the measurements 450 are no longer relevant to the current position estimate 460, then the method 400 returns to stage 404 with new measurements.

The quality metric 456 may be calculated using the position estimate 460 and the LOS postfit residuals 454, and without using the NLOS/MP-predicted measurements 458 and/or the position estimate uncertainty value 462. The quality metric 456 is also independent of the position estimate uncertainty value 462 associated with the position estimate 460 and to factors used to calculate the position estimate uncertainty value 462, such as the pseudorange weights modeling or the postfit residual covariance matrix. In at least this manner, the quality metric 456 is positioning algorithm agnostic, i.e., independent of the positioning algorithm used to calculate the position estimate 460, where the value of the quality metric 456 does not change due to the positioning algorithm used.

The frequency in which the quality metric 456 is determined may be based on various factors, which may be applicable to instantaneous single position estimates and continuous tracking position estimates. In one example, the quality metric 456 may be determined for each position estimate 460 for the UE 105. In another example, the quality metric 456 may be determined less frequently than each position estimate 460, such as for the purpose of conserving battery life. For another example, the frequency of determining the quality metric 456 may be based on efficiency factors, e.g., the quality metric 456 may be determined at one given frequency when the UE 105 is determined to be in a dense urban area, while determined at a lower frequency than the given frequency when the UE 105 is determined to be in an open or in flat terrain.

In one example, stages 402, 404, 406, 408, 410, and 412 may be repeated for different positioning algorithms, with a quality metric 456 calculated for the position estimate 460 calculated using each positioning algorithm. Since the calculation of each quality metric 456 is independent of the positioning algorithm used to calculate the corresponding position estimate 460, the quality metrics 456 may be directly compared and used to select the position estimate 460 with the best quality, without the need to resort to heuristic approaches. For example, the position estimate 460 with the lowest quality metric 456 may be selected as being the most accurate. Indications of the selected position estimate 460 and the corresponding quality metric 456 may then be output.

### IMPLEMENTATION EXAMPLES

Implementation examples are provided in the following numbered clauses.
Clause 1. A method of assessing a quality of a position estimate for a user equipment (UE), comprising: identifying one or more devices as a line-of-sight (LOS) devices based on a classification of one or more measurements of one or more signals from the one or more devices as being LOS measurements; determining one or more LOS postfit residuals for each LOS device based on the position estimate for the UE and the LOS measurements from the LOS device; and determining a quality metric for the position estimate for the UE based on the one or more LOS postfit residuals corresponding to the LOS devices.
Clause 2. The method of clause 1, wherein the one or more LOS postfit residuals represent one or more differences between one or more estimated distances between each LOS device and the UE and one or more actual range measurements for each LOS device.
Clause 3. The method of clause 1, further comprising: identifying one or more second devices as a non-LOS device based on a second classification of one or more second measurements from the one or more second devices as being non-LOS measurements.
Clause 4. The method of clause 3, wherein the determining of the one or more LOS postfit residuals comprises: excluding the non-LOS measurements in the determining of the one or more LOS postfit residuals.
Clause 5. The method of clause 1, wherein the calculating of the quality metric is independent of a positioning algorithm used to determine the position estimate for the UE.
Clause 6. The method of clause 1, wherein the determining of the one or more LOS postfit residuals is independent of one or more position estimate uncertainty values corresponding to the position estimate for the UE.
Clause 7. The method of clause 6, wherein the calculating of the quality metric is independent of factors selected from a group consisting of pseudorange weights modeling and a postfit residual covariance matrix.
Clause 8. A user equipment (UE), comprising: a receiver; one or more memories; and one or more processors communicatively coupled to the one or more memories, the one or more processors being configured to: identify one or more devices as a line-of-sight (LOS) device based on a classification of one or more measurements of one or more signals, from the one or more devices and received by the receiver, as being LOS measurements; determine one or more LOS postfit residuals for each LOS device based on a position estimate for the UE and the LOS measurements from the LOS device; and determine a quality metric for the position estimate for the UE based on the one or more LOS postfit residuals corresponding to the LOS devices.
Clause 9. The UE of clause 8, wherein the one or more LOS postfit residuals represent one or more differences between one or more estimated distances between each LOS device and the UE and one or more actual range measurements for each LOS device.
Clause 10. The UE of clause 8, wherein the processor-readable instructions further comprise processor-readable instructions to cause the one or more processors: identify one or more second SVs as a non-LOS device based on a second classification of one or more second measurements from the one or more second devices as being non-LOS measurements.
Clause 11. The UE of clause 10, wherein the processor-readable instructions to cause the one or more processors to determine of the one or more LOS postfit residuals further comprise process-readable instructions to cause the one or more processors to: exclude the non-LOS measurements in the determining of the one or more LOS postfit residuals.
Clause 12. The UE of clause 8, wherein the processor-readable instructions to cause the one or more processors to calculate the quality metric are independent of a positioning algorithm used to determine the position estimate for the UE.
Clause 13. The UE of clause 8, wherein the processor-readable instructions to cause the one or more processors to determine the one or more LOS postfit residuals are independent of one or more position estimate uncertainty values corresponding to the position estimate for the UE.

Clause 14. The UE of clause 13, wherein the processor-readable instructions to cause the one or more processors to calculate the quality metric is independent of factors selected from a group consisting of pseudorange weights modeling and a postfit residual covariance matrix.
Clause 15. A user equipment (UE), comprising: means for identifying one or more devices as a line-of-sight (LOS) device based on a classification of one or more measurements of one or more signals from the one or more devices as being LOS measurements; means for determining one or more LOS postfit residuals for each LOS device based on the position estimate for the UE and the LOS measurements from the LOS device; and means for determining a quality metric for the position estimate for the UE based on the one or more LOS postfit residuals corresponding to the LOS devices.
Clause 16. The UE of clause 15, wherein the one or more LOS postfit residuals represent one or more differences between one or more estimated distances between each LOS device and the UE and one or more actual range measurements for each LOS device.
Clause 17. The UE of clause 15, further comprising: means for identifying one or more second SVs as a non-LOS device based on a second classification of one or more second measurements from the one or more second devices as being non-LOS measurements.
Clause 18. The UE of clause 17, wherein the means for determining the one or more LOS postfit residuals comprise: means for excluding the non-LOS measurements in the determining of the one or more LOS postfit residuals.
Clause 19. The UE of clause 15, wherein the means for calculating of the quality metric are independent of a positioning algorithm used to determine the position estimate for the UE.
Clause 20. The UE of clause 15, wherein the means for determining of the one or more LOS postfit residuals are independent of one or more position estimate uncertainty values corresponding to the position estimate for the UE.
Clause 21. The UE of clause 20, wherein the calculating of the quality metric is independent of factors selected from a group consisting of pseudorange weights modeling and a postfit residual covariance matrix.
Clause 22. A non-transitory, processor-readable storage medium comprising processor-readable instructions to cause one or more processors to: identify one or more devices as a line-of-sight (LOS) device based on a classification of one or more measurements of one or more signals from the one or more devices as being LOS measurements; determining one or more LOS postfit residuals for each LOS device based on a position estimate for the UE and the LOS measurements from the LOS device; and determining a quality metric for the position estimate for the UE based on the one or more LOS postfit residuals corresponding to the LOS devices.
Clause 23. The medium of clause 22, wherein the one or more LOS postfit residuals represent one or more differences between one or more estimated distances between each LOS device and the UE and one or more actual range measurements for each LOS device.
Clause 24. The medium of clause 22, wherein the processor-readable instructions further comprise processor-readable instructions to cause the one or more processors: identify one or more second devices as a non-LOS device based on a second classification of one or more second measurements from the one or more second devices as being non-LOS measurements.
Clause 25. The medium of clause 24, wherein the processor-readable instructions to cause the one or more processors to determine of the one or more LOS postfit residuals further comprise process-readable instructions to cause the one or more processors to: exclude the non-LOS measurements in the determining of the one or more LOS postfit residuals.
Clause 26. The medium of clause 22, wherein the processor-readable instructions to cause the one or more processors to calculate the quality metric is independent of a positioning algorithm used to determine the position estimate for the UE.
Clause 27. The medium of clause 22, wherein the processor-readable instructions to cause the one or more processors to determine the one or more LOS postfit residuals is independent of one or more position estimate uncertainty values corresponding to the position estimate for the UE in the determining of the one or more LOS postfit residuals.
Clause 28. The medium of clause 27, wherein the processor-readable instructions to cause the one or more processors to calculate the quality metric is independent of factors selected from a group consisting of pseudorange weights modeling and a postfit residual covariance matrix.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes one or more of such devices (e.g., “a processor” includes one or more processors, “the processor” includes one or more processors, “a memory” includes one or more memories, “the memory” includes one or more memories, etc.). The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A method of assessing a quality of a position estimate for a user equipment (UE), comprising:
identifying one or more devices as a line-of-sight (LOS) devices based on a classification of one or more measurements of one or more signals from the one or more devices as being LOS measurements;
determining one or more LOS postfit residuals for each LOS device based on the position estimate for the UE and the LOS measurements from the LOS device; and
determining a quality metric for the position estimate for the UE based on the one or more LOS postfit residuals corresponding to the LOS devices.

2. The method of claim 1, wherein the one or more LOS postfit residuals represent one or more differences between one or more estimated distances between each LOS device and the UE and one or more actual range measurements for each LOS device.

3. The method of claim 1, further comprising:
identifying one or more second devices as a non-LOS device based on a second classification of one or more second measurements from the one or more second devices as being non-LOS measurements.

4. The method of claim 3, wherein the determining of the one or more LOS postfit residuals comprises: excluding the non-LOS measurements in the determining of the one or more LOS postfit residuals.

5. The method of claim 1, wherein the calculating of the quality metric is independent of a positioning algorithm used to determine the position estimate for the UE.

6. The method of claim 1, wherein the determining of the one or more LOS postfit residuals is independent of one or more position estimate uncertainty values corresponding to the position estimate for the UE.

7. The method of claim 6, wherein the calculating of the quality metric is independent of factors selected from a group consisting of pseudorange weights modeling and a postfit residual covariance matrix.

8. A user equipment (UE), comprising:
a receiver;
one or more memories; and
one or more processors communicatively coupled to the one or more memories, the one or more processors being configured to:
identify one or more devices as a line-of-sight (LOS) device based on a classification of one or more measurements of one or more signals, from the one or more devices and received by the receiver, as being LOS measurements;
determine one or more LOS postfit residuals for each LOS device based on a position estimate for the UE and the LOS measurements from the LOS device; and
determine a quality metric for the position estimate for the UE based on the one or more LOS postfit residuals corresponding to the LOS devices.

9. The UE of claim 8, wherein the one or more LOS postfit residuals represent one or more differences between one or more estimated distances between each LOS device and the UE and one or more actual range measurements for each LOS device.

10. The UE of claim 8, wherein the processor-readable instructions further comprise processor-readable instructions to cause the one or more processors:
identify one or more second SVs as a non-LOS device based on a second classification of one or more second measurements from the one or more second devices as being non-LOS measurements.

11. The UE of claim 10, wherein the processor-readable instructions to cause the one or more processors to determine of the one or more LOS postfit residuals further comprise process-readable instructions to cause the one or more processors to: exclude the non-LOS measurements in the determining of the one or more LOS postfit residuals.

12. The UE of claim 8, wherein the processor-readable instructions to cause the one or more processors to calculate the quality metric are independent of a positioning algorithm used to determine the position estimate for the UE.

13. The UE of claim 8, wherein the processor-readable instructions to cause the one or more processors to determine the one or more LOS postfit residuals are independent of one or more position estimate uncertainty values corresponding to the position estimate for the UE.

14. The UE of claim 13, wherein the processor-readable instructions to cause the one or more processors to calculate the quality metric is independent of factors selected from a group consisting of pseudorange weights modeling and a postfit residual covariance matrix.

15. A user equipment (UE), comprising:
means for identifying one or more devices as a line-of-sight (LOS) device based on a classification of one or more measurements of one or more signals from the one or more devices as being LOS measurements;
means for determining one or more LOS postfit residuals for each LOS device based on the position estimate for the UE and the LOS measurements from the LOS device; and
means for determining a quality metric for the position estimate for the UE based on the one or more LOS postfit residuals corresponding to the LOS devices.

16. The UE of claim 15, wherein the one or more LOS postfit residuals represent one or more differences between one or more estimated distances between each LOS device and the UE and one or more actual range measurements for each LOS device.

17. The UE of claim 15, further comprising:
means for identifying one or more second SVs as a non-LOS device based on a second classification of one or more second measurements from the one or more second devices as being non-LOS measurements.

18. The UE of claim 17, wherein the means for determining the one or more LOS postfit residuals comprise: means for excluding the non-LOS measurements in the determining of the one or more LOS postfit residuals.

19. The UE of claim 15, wherein the means for calculating of the quality metric are independent of a positioning algorithm used to determine the position estimate for the UE.

20. The UE of claim 15, wherein the means for determining of the one or more LOS postfit residuals are independent of one or more position estimate uncertainty values corresponding to the position estimate for the UE.
